(19) United States
(12) Patent Application Publication
(10) Pub. No.: US 2007/0182911 A1
(43) Pub. Date: Aug. 9, 2007

(54) Signal transmission film and display device including the same

(76) Inventor: Ki Seok Cha, Yongin-si (KR)

Correspondence Address: CANTOR COLBURN, LLP, 55 GRIFFIN ROAD SOUTH, BLOOMFIELD, CT, 06002, US

(21) Appl. No.: 11/510,936

(22) Filed: Aug. 28, 2006

(30) Foreign Application Priority Data
Feb. 6, 2006 (KR) 2006-0011108

(51) Int. Cl. G02F 1/1345

(52) U.S. Cl. 349/150

(57) ABSTRACT

A signal transmission film and a display device including the same are provided to prevent a crack defect of signal terminals caused by an external stress. The display device includes a display panel for displaying an image, a printed circuit board arranged separately from one side of the display panel, and a plurality of signal transmission films attached between the display panel and the printed circuit board. At least one of the plurality of signal transmission films includes an input portion in which input pads contacting the printed circuit board are formed, an output portion in which output pads contacting the display panel are formed, and a channel portion disposed between the input and output portions and formed to be narrower than a width of at least one of the input and output portions.

This application claims priority to Korean Patent Application No. 2006-0011108, filed on Feb. 6, 2006, and all the benefits accruing therefrom under 35 U.S.C. §119, and the contents of which in its entirety are hereby incorporated by reference.

### BACKGROUND OF THE INVENTION

1. Field of the Invention

The present invention relates to a signal transmission film and a display device including the same, and more particularly, to a signal transmission film capable of preventing a crack defect of signal terminals caused by an external stress, and a display device including the same.

2. Description of the Related Art

A liquid crystal display (LCD) device controls light transmittance of liquid crystals that are disposed between electrodes of an LCD panel and having dielectric anisotropy by using an electric field, thereby displaying an image. The LCD device includes liquid crystal cells arrayed in a matrix form, as well as driving circuits for driving the LCD panel.

The driving circuits include a gate driving integrated circuit (IC) for driving gate lines of the LCD panel, a data driving IC for driving data lines of the LCD panel, a timing controller for controlling driving timings of the gate and data driving ICs, and a power source for supplying power signals necessary for driving the LCD panel and the driving circuits.

The data and gate driving ICs are mounted on tape carrier packages. The tape carrier packages on which these ICs are mounted are attached between a printed circuit board (PCB) on which the timing controller and the power source are mounted and the LCD panel by a thermocompression process. However, high temperatures typically generated during the thermocompression process can cause thermal deformation of the tape carrier package. This thermal deformation, in turn, may result in the formation of cracks in the signal terminals mounted on the tape carrier package when an external stress is applied thereto.

### BRIEF SUMMARY OF THE INVENTION

The present invention provides a signal transmission film capable of preventing a crack defect of signal terminals caused by external stress, and a display device including the signal transmission film.

In order to achieve the above and other objects of the invention a display device according to one aspect of the present invention includes a display panel for displaying an image, a printed circuit board arranged separately from one side of the display panel, and a plurality of signal transmission films attached between the display panel and the printed circuit board, wherein at least one of the plurality of signal transmission films includes an input portion in which input pads contacting the printed circuit board are formed, an output portion in which output pads contacting the display panel are formed, and a channel portion disposed between the input and output portions and formed to be narrower than a width of at least one of the input and output portions.

An inflection point formed on at least one of the input portion, the output portion and the channel portion is in a round shape.

The signal transmission film is at least one of a tape carrier package, a flexible printed circuit and a chip-on-film.

The signal transmission film becomes gradually narrower in a width of the channel portion as its attached position is toward the outer side of the display panel from the center of the display panel.

The channel potion of each of the signal transmission films attached to the outer side of the display panel is narrower than that of the channel portion of each of the signal transmission films attached to the other regions.

In accordance with another aspect of the present invention, there is provided a signal transmission film, including a base film, an input and output lines formed on the base film, an input and output pads formed on the base film and connected respectively to the input and output lines, and a protective layer formed on the base film to cover the input and output lines, wherein a width of the base film on which the input and output lines are formed is narrower than that of the base film on which the input and output pads are formed.

An inflection point of at least one of the base film and the protective layer is in a round shape.

An interval between the input pads is wider than that between the input lines, and an interval between the output pads is wider than that between the output lines.

In accordance with still another aspect of the present invention, there is provided a signal transmission film, including an input portion in which input pads are formed, an output portion in which output pads are formed, and a channel portion disposed between the input and output portions and formed to be narrower than a width of at least one of the input and output portions.

An inflection point formed on at least one of the input portion, the output portion and the channel portion is in a round shape.

### BRIEF DESCRIPTION OF THE DRAWINGS

The above and other objects, features and advantages of the present invention will become more apparent from the following detailed description when taken in conjunction with the accompanying drawings in which:

FIG. 1 is a front perspective view of an exemplary embodiment of a tape carrier package according to the present invention;

FIG. 2 is a rear perspective view of an exemplary embodiment of a tape carrier package according to the present invention;

FIGS. 3A and 3B are cross-sectional views of the tape carrier of FIG. 2 taken along lines II-II and II′-II′;

FIG. 4 is a plan view of an exemplary embodiment of a tape carrier package illustrating the influence of an external stress applied thereon according to the present invention;

FIG. 5 is a plan view of an exemplary embodiment of a tape carrier package on which inflection points are formed in a round shape according to the present invention;

FIG. 6 is a block diagram of an exemplary LCD device including a tape carrier package with a data printed circuit board (PCB) and thin film transistor (TFT) according to the present invention; and

FIGS. 7A and 7B are diagrams illustrating various exemplary embodiments of a tape carrier package attached between the data PCB and thin film transistor substrate shown in FIG. 6.

### DETAILED DESCRIPTION OF THE INVENTION

The invention will now be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

The exemplary embodiments of the present invention will now be described with reference to the attached drawings.

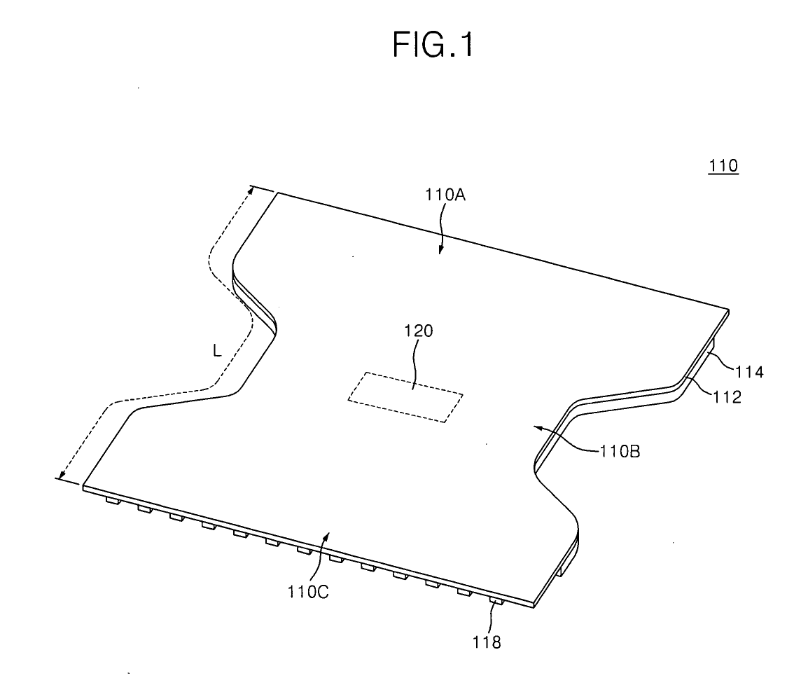

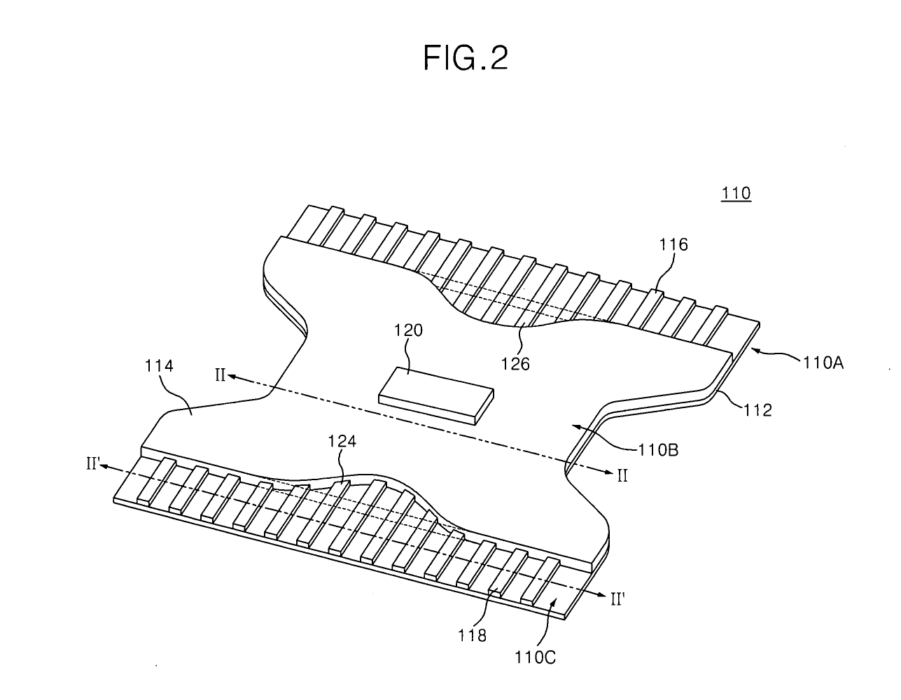

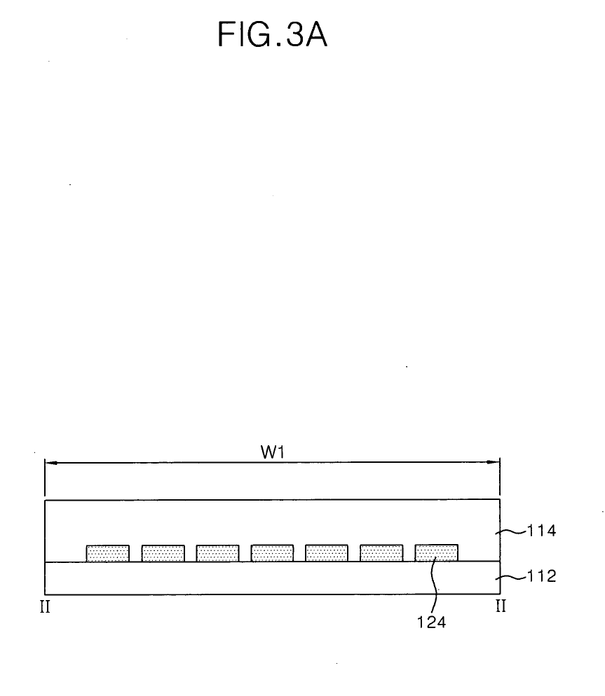

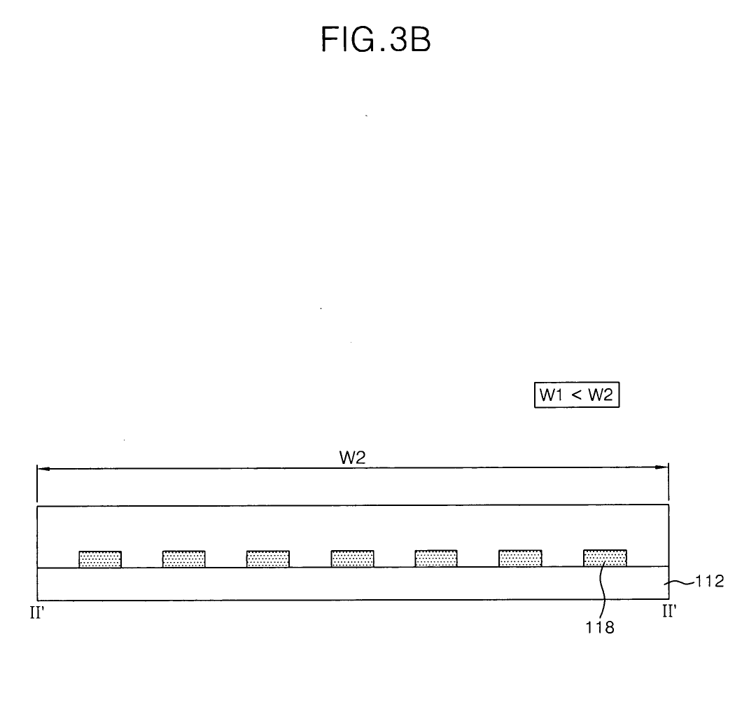

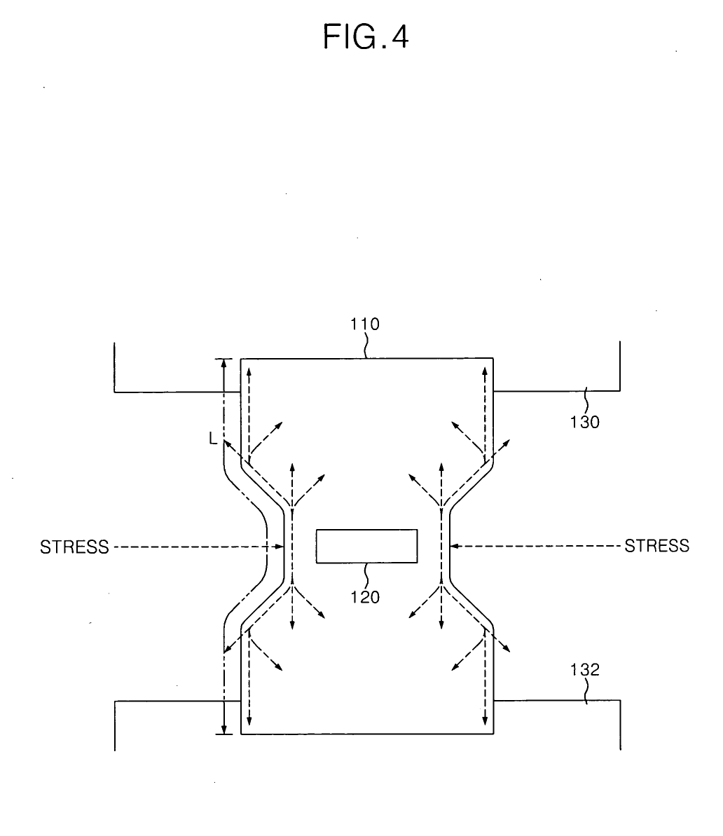

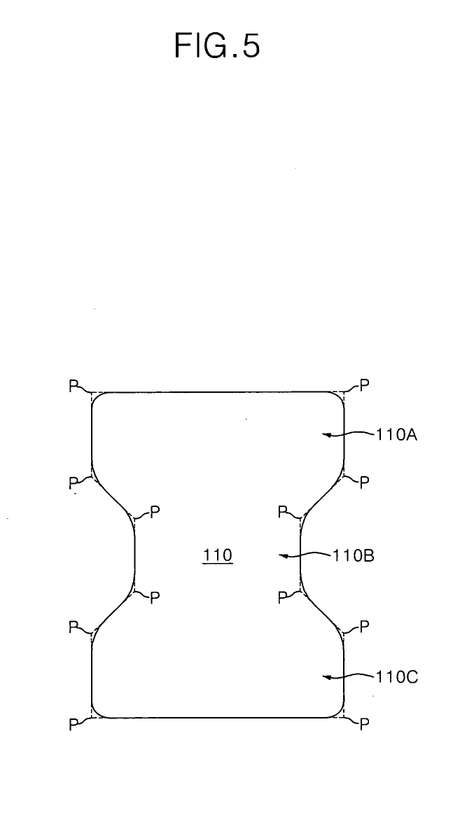

FIGS. 1 and 2 are front and rear perspective views of an exemplary embodiment of a tape carrier package according to the present invention. FIGS. 3A and 3B are cross-sectional views of the tape carrier package of FIG. 2 taken along lines II-II and II′-II′. FIG. 4 is a plan view of a tape carrier package illustrating the influence of an external stress applied to the tape carrier package according to the present invention. FIG. 5 is a plan view of an exemplary embodiment of a tape carrier package on which inflection points are formed in a round shape according to the present invention.

Referring now to FIGS. 1 and 2, an exemplary tape carrier package 110 according to the present invention includes a base film 112, input and output pads 116 and 118, respectively, formed on the base film 112, and a protective layer 114 formed to expose the input and output pads 116 and 118.

The base film 112 is formed to have different widths at input and output portions 110A and 110C, respectively, and at a channel portion 110B between the input and output portions 110A and 110C. The input pads 116 for supplying an input signal to an integrated circuit (IC) 120 mounted on the channel portion 110B are formed on the base film 112 of the input portion 110A. The output pads 118 for outputting an output signal from the IC 120 mounted on the channel portion 110B are formed on the base film 112 of the output portion 110C. A line width W2 of the base film 112 of each of the input and output portions 110A and 110C is wider than a line width W1 of the base film 112 of the channel portion 110B, as illustrated in FIGS. 3A and 3B. The IC 120 for generating the output signal by using the input signal is formed on the base film 112 of the channel portion 110B. Moreover, a plurality of input lines 126 are formed on the base film 112 of the channel portion 110B, and which are connected to the input pads 116 for supplying the input signal to input terminals of the IC 120. Further, a plurality of output lines 124 are connected to output terminals of the IC 120 for supplying the output signal from the IC 120 to the output pads 118.

As illustrated in FIGS. 3A and 3B, the line width W1 of the base film 112 of the channel portion 110B is narrower than the line width W2 of the base film 112 of each of the input and output portions 110A and 110C. In exemplary embodiments, the base film 112 of the channel portion 110B has a width which becomes gradually narrower toward a region on which the IC 120 is mounted from a region adjacent to the base film 112 of each of the input and output portions 110A and 110C, respectively, and the region on which the IC 120 is mounted is maintained at a minimum width. Since the width of the channel portion 110B is narrower than that of each of the input and output portions 110A and 110C, intervals between the input lines 126 and between the output lines 124 formed on the base film 112 of the channel portion 110B are respectively narrower than intervals between the input pads 116 and between the output pads 118 formed on the base film 112 of the input and output portions 110A and 110C.

As described above, the width of the base film 112 of the channel portion 110B is narrower than that of the base film 112 of each of the input and output portions 110A and 110C. Therefore, a moving path of a stress becomes proportionately long with respect to a lateral length L of the tape carrier package 110. If the moving path of the stress becomes long, any influence of the stress on the input and output lines 126 and 124 and the input and output pads 116 and 118 of the tape carrier package is relatively reduced, thereby preventing a crack phenomenon.

Referring to FIGS. 2 and 5, a stress applied from the exterior is dispersed in various directions at inflection points P of the channel portion 110B and at inflection points P between each of the input and output portions 110A and 110C and the channel portion 110B. The stress dispersed in various directions has a lesser effect on the tape carrier package 110 than the case where the stress is not dispersed. Accordingly, a crack phenomenon of the input and output lines 126 and 124 and the input and output pads 116 and 118 formed on the tape carrier package 110 is prevented.

The input pads 116 are connected to an input signal supplier 132 shown in FIG. 4, for example, to a printed circuit board (PCB) via an anisotropic conductive film (ACF). The input pads 116 are extended from the input lines 126 connected to the input terminals of the IC 120. The input pads 116 and the input lines 126 are formed of a metal having good conductivity. For example, the input pads 116 and the input lines 126 may be formed of copper (Cu) having good conductivity or of tin (Sn) formed on Cu for preventing oxidation of Cu.

The output pads 118 are connected to an output signal supplier 130 shown in FIG. 4, for example, to signal pads of an LCD panel via the ACF. The output pads 118 are extended from the output lines 124 connected to the output terminals of the IC 120. The output pads 118 and the output lines 124 are formed of a metal having good conductivity. For example, the output pads 118 and the output lines 124 may be formed of Cu having good conductivity or of Sn formed on Cu for preventing oxidation of Cu.

The protective layer 114 is formed on the base film 112 of the channel portion 110B to expose the input and output pads 116 and 118 and to protect the input and output lines 126 and 124 and has the same pattern as the channel portion 110B. The protective layer 114 may be formed of a solder register.

Meanwhile, the inflection points P formed on the input and output portions 110A and 110C and the channel portion 110B of the tape carrier package 110 may be formed in a round shape as shown in FIG. 5. Then the tape carrier package 110 can be protected from being torn due to the external stress.

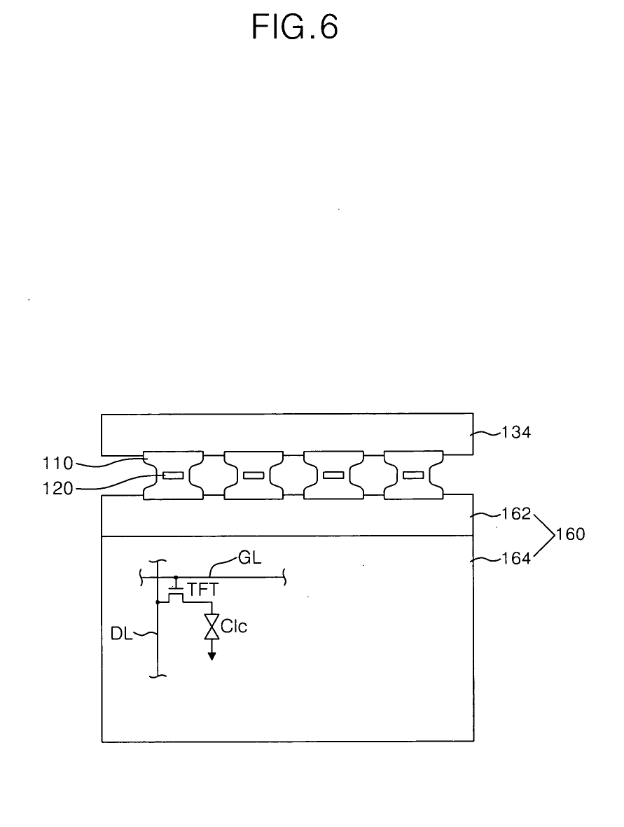

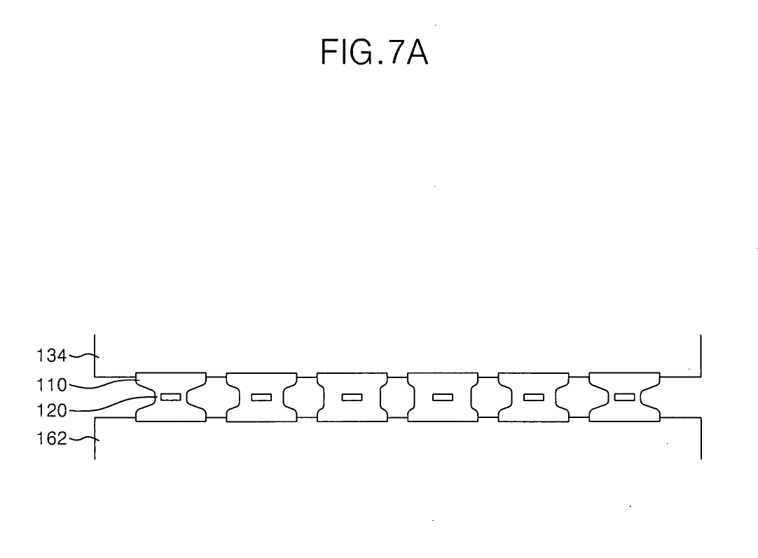

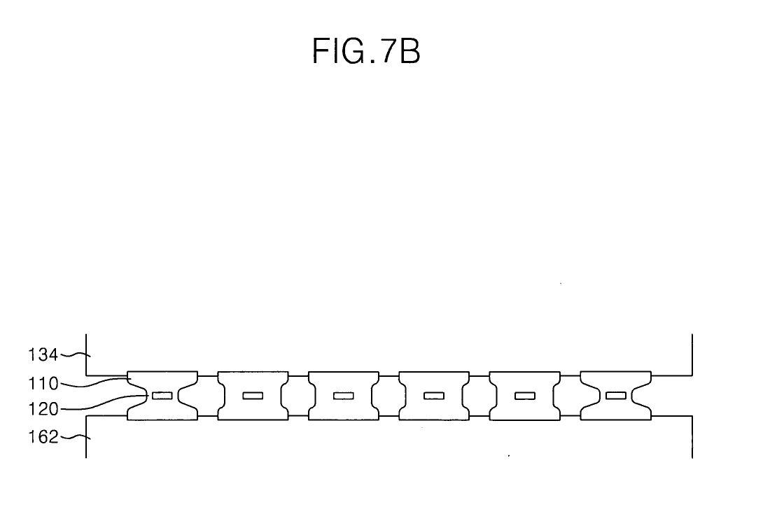

FIG. 6 is a block diagram of an exemplary LCD device including a tape carrier package with a data printed circuit board (PCB) and thin film transistor (TFT) substrate according to the present invention. FIGS. 7A and 7B are diagrams for describing various exemplary embodiments of a tape carrier package attached between the data PCB and thin film transistor substrate shown in FIG. 6.

Referring to FIG. 6, the LCD device includes an LCD panel 160, a data PCB 134 on which the timing controller, the power source, etc. are mounted, and the tape carrier package 110 attached between the LCD panel 160 and the data PCB 134.

The LCD panel 160 is formed by assembling a thin film transistor (TFT) substrate 162 and a color filter substrate 164 with liquid crystals disposed therebetween. Liquid crystal cells Clc driven independently by TFTs are provided on every region defined by intersections of gate lines GL and data lines DL in the LCD panel 160. A gate driving circuit (not shown) consisting of driving transistors formed by the same process as the TFTs is formed on the TFT substrate 162 of the LCD panel 160. The gate driving circuit sequentially supplies a scan signal of a gate high voltage to the gate lines GL. The gate driving circuit also supplies a gate low voltage to the gate lines GL during a period except while the gate high voltage is supplied.

The timing controller and the power source are mounted on the data PCB 134. A control signal, a power signal, pixel data, etc. from the timing controller and the power source are supplied to the IC 120 mounted on the tape carrier package 110.

The tape carrier package 110 is attached between the TFT substrate 162 of the LCD panel 160 and the data PCB 134. The IC 120 is mounted on the tape carrier package 110. The IC 120 converts the pixel data into an analog pixel signal and supplies the converted signal to the data lines DL.

Since the tape carrier package 110 is formed such that the width of the channel portion 110B is narrower than that of each of the input and output portions 110A and 110C, a crack phenomenon of the input and output lines 126 and 124 and the input and output pads 116 and 118 caused by the external stress can be prevented. In particular, the tape carrier packages 110 positioned at the outermost side of the TFT substrate 162 (or the data PCB 134) that is most strongly influenced by the stress form a width of the channel portion 110B which is narrower than the other tape carrier packages 110 as shown in FIGS. 7A and 7B, thereby reducing defects caused by the stress. For instance, the width of the channel portion 110B of each of the tape carrier packages 110 becomes narrower toward the outer side of the TFT substrate 162 (or the PCB 134) from the center thereof as illustrated in FIG. 7A. Alternatively, the width of the channel portion 110B of each of the tape carrier packages 110 may be the same except for the tape carrier packages attached to the outermost sides of the TFT substrate 162 (or the PCB 134), as shown in FIG. 7B.

Although the present invention has been shown and described with reference to the LCD device, it is not limited thereto and it is applicable to, for example, a plasma display panel (PDP), a field emission device, etc. Moreover, the present invention is applicable to a chip-on-film (COF), a flexible printed circuit (FPC), etc. in addition to the tape carrier package.

As is apparent from the foregoing description, since the width of the channel portion of the tape carrier package is narrower than that of the input and output portions thereof, a moving path of a stress becomes long. Therefore, the tape carrier package and the LCD device including the tape carrier package can prevent a crack phenomenon because an effect of a stress on the input and output lines and the input and output pads is decreased even if the same external stress as in a conventional circumstance is given.

Furthermore, a stress at inflection points of the channel portion and at inflection points between each of the input and output portions and the channel portion is dispersed in various directions. The stress dispersed in various directions diminishes the aforementioned adverse effects on the tape carrier package as compared to a tape carrier package where the stress is not dispersed and, thus, preventing or minimizing a crack phenomenon of the input and output lines and input and output pads formed on the tape carrier package.

It will be apparent to those skilled in the art that various modifications and variations can be made in the present invention without departing from the spirit or scope of the invention. Thus, it is intended that the present invention cover the modifications and variations of this invention provided that come within the scope of the appended claims and their equivalents.

What is claimed is:

1. A display device, comprising:
a display panel for displaying an image;
a printed circuit board arranged separately from one side of the display panel; and
a plurality of signal transmission films attached between the display panel and the printed circuit board,
wherein at least one of the plurality of signal transmission films includes an input portion in which input pads contacting the printed circuit board are formed, an output portion in which output pads contacting the display panel are formed, and a channel portion disposed between the input and output portions and formed to be narrower than a width of at least one of the input and output portions.

2. The display device as claimed in claim 1, wherein an inflection point formed on at least one of the input portion, the output portion and the channel portion is in a round shape.

3. The display device as claimed in claim 1, wherein the signal transmission film is at least one of a tape-carrier package, a flexible printed circuit and a chip-on-film.

4. The display device as claimed in claim 2, wherein the signal transmission film is at least one of a tape carrier package, a flexible printed circuit and a chip-on-film.

5. The display device as claimed in claim 1, wherein the signal transmission film becomes gradually narrower in a width of the channel portion as its attached position is toward the outer side of the display panel from the center of the display panel.

6. The display device as claimed in claim 1, wherein a width of the channel potion of each of the signal transmission films attached to the outer side of the display panel is narrower than that of the channel portion of each of the signal transmission films attached to the other regions.

7. A signal transmission film, comprising:
a base film;
an input and output lines formed on the base film;
an input and output pads formed on the base film and connected to respective input and output lines; and
a protective layer formed on the base film to cover the input and output lines,
wherein a width of the base film on which the input and output lines are formed is narrower than that of the base film on which the input and output pads are formed.

8. The signal transmission film as claimed in claim 7, wherein an inflection point of at least one of the base film and the protective layer is in a round shape.

9. The signal transmission film as claimed in claim 7, wherein an interval between the input pads is wider than that between the input lines, and an interval between the output pads is wider than that between the output lines.

10. The signal transmission film as claimed in claim 8, wherein an interval between the input pads is wider than that between the input lines, and an interval between the output pads is wider than that between the output lines.

11. A signal transmission film, comprising:
an input portion in which input pads are formed;
an output portion in which output pads are formed; and
a channel portion disposed between the input and output portions and formed to be narrower than a width of at least one of the input and output portions.

12. The signal transmission film as claimed in claim 11, wherein an inflection point formed on at least one of the input portion, the output portion and the channel portion is in a round shape.
